(19) United States
(12) Patent Application Publication
(10) Pub. No.: US 2005/0157774 A1
(43) Pub. Date: Jul. 21, 2005

(54) Probeless dry ice sensor

(75) Inventors: Jeffrey DiLuiso, Beverly, MA (US); Rupert A. Schmidtberg, Westford, MA (US)

Correspondence Address: Randy J. Pritzker;Wolf, Greenfield & Sacks, P.C., 600 Atlantic Avenue, Boston, MA, 02210-2206, US

(73) Assignee: Sensitech, Inc., Beverly, MA (US)

(21) Appl. No.: 10/987,275

(22) Filed: Nov. 12, 2004

Related U.S. Application Data
(60) Provisional application No. 60/519,458, filed on Nov. 12, 2003.

(51) Int. Cl. G01K 13/00; G01K 1/00; G01K 7/00

(52) U.S. Cl. 374/163; 374/208

(57) ABSTRACT

One embodiment of the invention is directed to a temperature monitor comprising a housing, a temperature sensor to provide temperature indications, wherein the temperature sensor is disposed inside the housing and exposed to an ambient temperature, circuitry within the housing for processing and storing the temperature indications, and a power supply within the housing and coupled to the circuitry. The power supply is adapted to provide a level of power to the circuitry sufficient for the operability of the circuitry at least at any ambient temperature between −40° C. and −80° C. Another embodiment of the invention is directed to a method comprising acts of exposing the interior of a housing to a temperature below −40° C., measuring the temperature in the interior of the housing, storing an indication of the temperature within the housing, and processing the indication of the temperature within the housing.

### CROSS-REFERENCE TO RELATED APPLICATIONS

This application claims priority under 35 U.S.C. § 119(e) to U.S. Provisional Application Ser. No. 60/519,458, entitled “Dry Ice Sensor with Liquid Crystal Display,” filed on Nov. 12, 2003, which is herein incorporated by reference in its entirety.

### FIELD OF THE INVENTION

The invention relates generally to methods and apparatus for temperature sensing and, more particularly, to methods and apparatus for sensing temperatures down to approximately −80° C. using a probeless sensor.

### DISCUSSION OF THE RELATED ART

For certain perishable and/or consumable products, it is often useful, and in some cases critical, to know the temperature conditions to which the product has been exposed. Many products typically are transported in some form of a “supply-chain” from the product manufacturer or source to a purchaser or end-user. During transportation in such a supply-chain, which may include several links and involve significant time periods (transport via land, sea and/or air, storage in one or more warehouses, etc.), products may be exposed to a wide variety of environmental conditions, some of which may cause degradation of, or damage to, the product.

For various products intended for human use or consumption (e.g., foods and food-related products, beverages, medicines, cosmetics, etc.), it is particularly useful to know if a given product has been exposed to undesirable temperature conditions (e.g., an undesirably high or low temperature, an undesirable duration at a temperature outside of a particular temperature range, an undesirable degree of temperature cycles or fluctuations, etc.). Such exposures can result in significant health and/or safety consequences. In some cases, products that are exposed to undesirable temperature conditions may be deemed unsafe for human consumption/use. Thus, information relating to various exposure conditions may be especially important in connection with medicines and other health-related products.

Certain products, such as reagents and pharmaceuticals require very cold temperatures during transit and storage, and accordingly may be packaged with dry ice to maintain the low temperature of the product. Conventional temperature sensing of products in a dry ice environment has been performed using a temperature monitor having an external probe. The probe is placed inside the packaging of the product to measure the temperature of the product.

### SUMMARY OF THE INVENTION

One embodiment of the invention is directed to a temperature monitor comprising a housing, a temperature sensor to provide temperature indications, wherein the temperature sensor is disposed inside the housing and exposed to an ambient temperature, circuitry within the housing for processing and storing the temperature indications, and a power supply within the housing and coupled to the circuitry. The power supply is adapted to provide a level of power to the circuitry sufficient for the operability of the circuitry at least at any ambient temperature between −40° C. and −80° C.

Another embodiment of the invention is directed to a method comprising acts of exposing the interior of a housing to a temperature below −40° C., measuring the temperature in the interior of the housing, storing an indication of the temperature within the housing, and processing the indication of the temperature within the housing.

A further embodiment of the invention is directed to a temperature monitor comprising a housing, a temperature sensor to provide temperature indications, and means, within the housing, for processing and storing the temperature indications, wherein said means is operable when exposed to a temperature of approximately −80° C.

Another embodiment of the invention is directed to a device, comprising a probeless temperature monitor, wherein the monitor is operable down to at least −80° C.

### BRIEF DESCRIPTION OF THE DRAWINGS

FIGS. 1A and 1B are top and side views, respectively, of a temperature monitor according to an embodiment of the invention;

FIG. 2 is a functional block diagram representation of a temperature monitor according to an embodiment of the invention;

FIG. 3 is a schematic representation of an exemplary implementation of the power supply shown in FIG. 2;

FIG. 4 is a schematic representation of an exemplary implementation of circuitry that comprises the microcontroller and LCD display of FIG. 2; and

FIG. 5 is a schematic representation of an exemplary implementation of circuitry that comprises the temperature sensing circuitry, optical communications circuitry, user interface, and data memory of FIG. 2.

### DETAILED DESCRIPTION

As discussed above, temperature sensing of products in a dry ice environment has conventionally been performed using a temperature monitor having an external probe placed inside the packaging of the product. However, temperature monitors with probes have a number of drawbacks. For example, one drawback associated with monitors with probes is that they may be mistaken for explosives when placed inside a package being transported. In particular, the wiring that is used to connect the probe to the body of the monitor may be mistaken for wiring of an explosive. Under the heightened standards imposed by the Transportation Security Administration (TSA), suspicious packages, such as those with loose wires, are reported to authorities. Another drawback of monitors with probes is that they require an opening to be created in the packaging of the product to allow the probe to be placed inside. Such tampering with the packaging of the product may be undesirable.

In view of the foregoing, one embodiment of the invention is directed to a temperature monitor that is capable of measuring very low temperatures, such as those encountered in a package including dry ice, without a probe. Implementing a temperature monitor capable of measuring very low temperatures without a probe presents an number of challenges. For example, in conventional temperature monitors with probes that are adapted to operate at very low temperatures, the body of the monitor is isolated from the ambient temperature since only the probe needs to be exposed to the temperature being measured. Thus, the electronics within the body of the monitor operate under normal temperature conditions.

However, in the embodiment of the invention wherein the temperature monitor is adapted to measure very low temperatures without a probe, the temperature is sensed within the body of the monitor. Thus, the interior of the body of the monitor, and hence the components within the monitor, must be exposed to the very low temperatures being measured. In certain temperatures ranges (e.g., below −40° C.), this may render conventional monitor components inoperable or unreliable. Accordingly, embodiments of the invention are directed to monitor components that are designed to be operable at very low temperatures (e.g., down to −80° C. or colder).

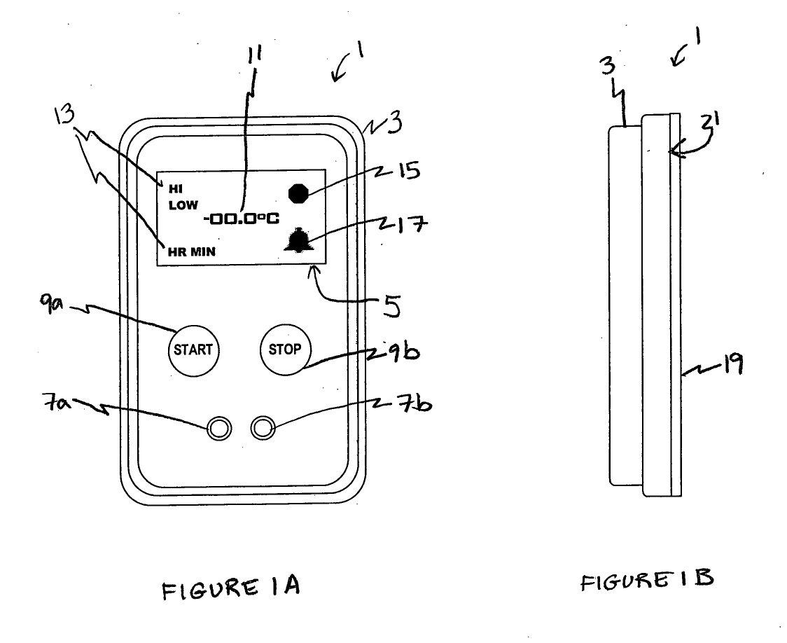

FIGS. 1A and 1B illustrate top and side views of a probeless monitor that is adapted to measure very low temperatures according to an embodiment of the invention. Monitor 1 includes a housing 3, which may be formed of a rigid, molded acrylonitrile butadiene-styrene (ABS) material. Monitor 1 further includes a liquid crystal display (LCD) 5 and optical ports 7a, 7b, which are visible through openings in the housing.

Optical port 7a may receive optical signals, while optical port 7b may transmit optical signals. For example, optical port 7a may receive configuration data and/or commands transmitted from an optical port coupled to a personal computer, personal digital assistant (PDA), or other remote device. Optical port 7b may transmit measured or processed temperature data to an optical port of a personal computer, PDA, or other remote device. The temperature information may then be stored, viewed, and/or manipulated on the personal computer. The optical signals received and transmitted by optical ports 7a and 7b, respectively, may be infrared signals, radio frequency (RF) signals, or a combination thereof. According to one example, optical port 7a is implemented using a phototransistor and optical port 7b is implemented using an infrared light-emitting diode (LED).

Control buttons 9a, 9b are also provided on the front surface of housing 3. In the example of FIG. 1, control button 9a is designated as a “start” button and control button 9b is designated as a “stop” button. The start button, when pressed initially, begins the temperature monitoring and data recording process. Information may also be displayed on LCD 5 when the start button is pressed initially. If the start button is pressed when the monitor is already turned on, it causes the information displayed on LCD 5 to change. Alternatively, if the first depression of the start button does not cause information to be displayed on LCD 5, the second depression of the start button may cause information to be displayed on LCD 5 and subsequent depressions of the start button may cause the information displayed on LCD 5 to change. The stop button may terminate the temperature monitoring and data recording process. Pressing the start button after the stop button has been pressed may cause information to be displayed on LCD 5, but not reinitiate temperature monitoring and data recording.

LCD 5 displays information about the measured temperature data. Examples of data that may be displayed are: a high temperature measured; a low temperature measured; an average temperature measured; an indication of whether the temperature measured fell below, above, or outside of a particular range; and an indication of the time the temperature measured fell below, above, or outside of a particular range. The data may be displayed as alphanumeric characters 1. Although a temperature is shown in FIG. 1A, alphanumeric characters may alternatively represent a time (e.g., hours and minutes), a percentage, a state, or another quantity or quality. Data indicators 13 may be displayed to indicate the nature of the information represented by alphanumeric characters 11 (e.g., a high temperature, a low temperature, or a duration in hours and minutes). LCD 5 may also display one or more icons. For example, LCD 5 may display a stop icon 15 to indicate that button 9b has been pressed and/or an alarm icon 17 to indicate. e.g., that the temperature measured fell below, above, or outside of a particular range.

An adhesive pad 19 may optionally be included on rear panel 21 of housing 3. The adhesive pad 19 may be used to adhere monitor 1 to a product being monitored or the packaging thereof. However, it should be appreciated that the monitor 1 need not be located on the product or packaging, and may simply be near the product. Furthermore, adhesive pad 19 may be substituted for or supplemented with another mechanism to couple monitor 1 to a product being monitored or the packaging thereof. For example, glue, Velcro, one or more clips, one or more straps, buttons or snaps, or some other coupling mechanism may alternatively be used.

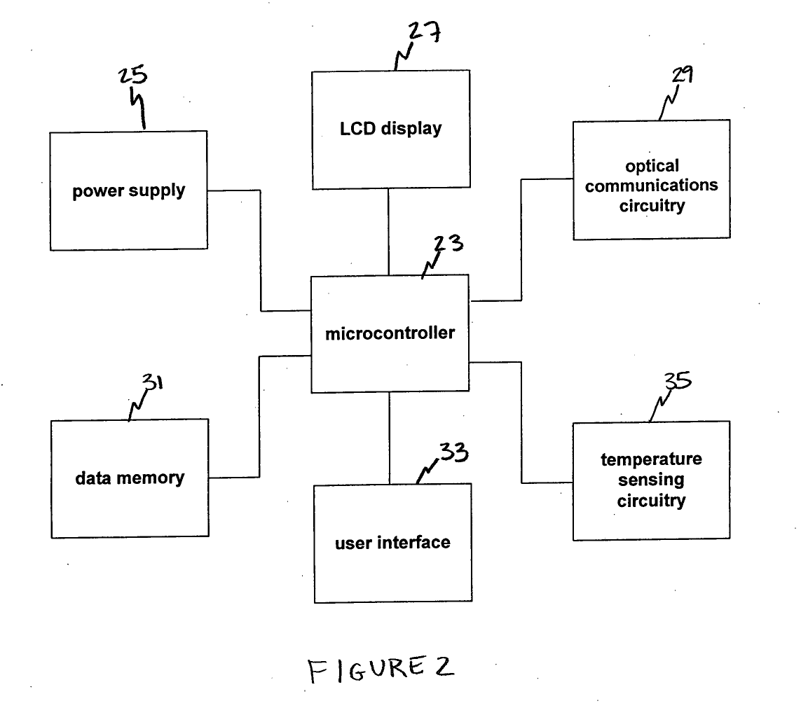

FIG. 2 illustrates an example of the components of a temperature monitor according to an embodiment of the invention. The monitor 22 comprises a microcontroller 23, which is coupled to a power supply 25, an LCD display 27, optical communications circuitry 29, a data memory 31, a user interface 33, and temperature sensing circuitry 35. Although not illustrated in FIG. 2, the monitor 22 may also include a housing such as the housing 3 shown in FIG. 1. Such a housing may at least partially enclose the components illustrated in FIG. 2.

The temperature within the monitor 22, which should substantially equilibrate to the ambient temperature of the monitor over a period of time, is measured by temperature sensing circuitry 35. Temperature sensing circuitry 35 comprises a temperature sensor, such as a thermistor, to sense the temperature within the monitor 22. If the temperature sensor provides an analog indication of temperature, temperature sensing circuitry 35 may include circuitry to convert the analog temperature signal to a digital temperature signal.

Memory 31 stores the measured temperature data. Microcontroller 23 may perform functions on the measured temperature data to, for example, determine properties of the measured temperature data. Such properties may be a high temperature measured, a low temperature measured, or an average temperature measured. The temperature data may also be processed to determine whether the temperature measured fell below, above, or outside of a particular range and, if so, the duration of time for which the temperature measured fell below, above, or outside of a particular range. The processed temperature data may also be stored in memory 31. In addition, memory 31 may also store calibration data for the monitor, such as the calibration data that may be received via optical communications circuitry 29, described below. The configuration data may include, for example, the sample rate for the monitor and the thresholds (e.g., maximum temperature, minimum temperature) that trigger an alarm indication on the LCD display 27.

Processed or measured temperature data may be viewable on the monitor 22 itself or remotely. On the monitor, such data may be displayed on LCD display 27 in any of the manners described in connection with FIG. 1A. Remotely, the data may be displayed on personal computer, PDA, or other remote device. Optical communications circuitry 29 may be used to transmit measured or processed temperature data to the remote device in any of the manners discussed in connection with FIG. 1A. In addition, optical communications circuitry 29 may be used to receive configuration data from a remote device as discussed in connection with FIG. 1A.

User interface 33 may include “start” and “stop” buttons as discussed in connection with FIGS. 1A or 1B, or another mechanism for communicating commands from a user to monitor 22. For example, user interface 33 may comprise one or more dials, sliding switches, flip switches, and/or touch sensors. The user interface 33 may be used to control the state of the monitor (e.g., on or off), the information that is displayed on LCD display 27, or another aspect of monitor 22.

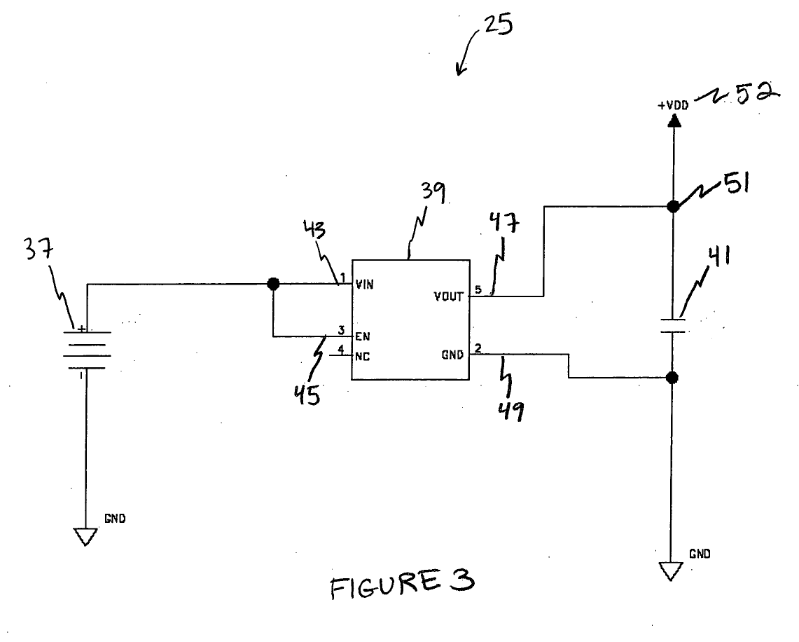

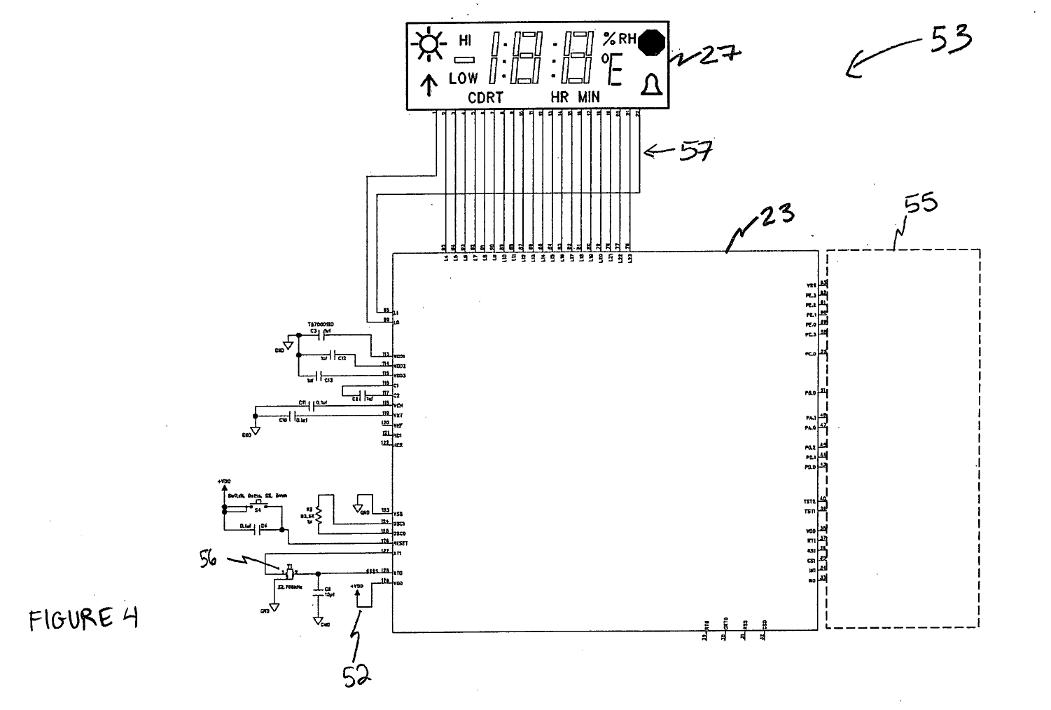

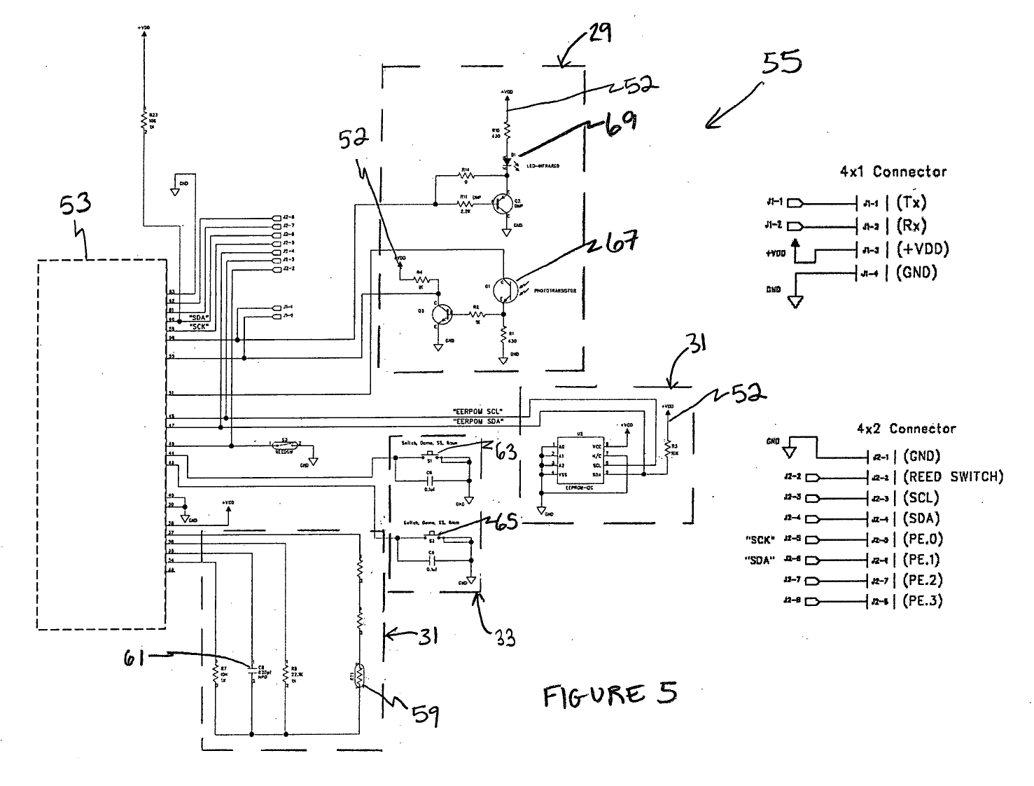

FIGS. 3, 4, and 5 illustrate an exemplary implementation of the monitor 22 illustrated functionally in FIG. 2. Specifically, FIG. 3 illustrates the power supply 25 of monitor 22. FIG. 4 illustrates circuitry 53 that comprises microcontroller 23 and LCD display 27 of monitor 22. Finally, FIG. 5 illustrates circuitry 55 that comprises the temperature sensing circuitry 35, optical communications circuitry 29, user interface 33, and data memory 31 of monitor 22, each of which is coupled to microcontroller 23 of circuitry 53 shown in FIG. 4.

FIG. 3 illustrates an exemplary implementation of power supply 25, shown FIG. 2. Power supply 25 comprises a battery 37, a voltage regulator 39, and a capacitor 41. The positive lead of battery 37 is coupled to voltage input 43 and enable input 45 of voltage regulator 39. Voltage regulator 39 includes a voltage output 47 and ground output 49. Capacitor 41 is connected, at one end, to voltage output 47 at a node 51 and, at the other end, to ground output 49.

The signal 52 at node 51 is supplied to portions of monitor 22 that require power (e.g., microcontroller 23, data memory 31, and optical communications circuitry 29). Thus, the voltage and current supplied by power supply 25 at node 51 should be sufficient to allow for reliable operation of monitor 22 at the temperatures at which the monitor is operable. At low temperatures, the chemical reactions of a battery slow, which reduces battery output. In particular, the available capacity of a battery (i.e., the amount of electrical charge the battery can hold) and the maximum current of a battery both drop at low temperatures. Such a drop could render a monitor inoperable. For example, if a power supply failed to provide sufficient power during acquisition of a temperature measurement by temperature sensing circuitry 35, the measurement could be corrupted.

According to one example, power supply 25 is designed to provide sufficient power (i.e., voltage and current) at temperatures below −40° C. For example, power supply 25 may be adapted to provide sufficient power at temperatures below −60° C., below −80° C., or at even lower temperatures. According to one example, the voltage supplied by power supply 25 is greater than or equal to 2.2 V. For example, the voltage supplied by power supply 25 may be approximately 2.8 V. The power supply 25 should be able to accommodate draws of approximately 8 mA at temperatures as low as −80° C. or colder. Certain current intensive processes such as transmitting information via optical communications circuitry 29 may require approximately 8 mA of current.

According to one exemplary implementation, battery 37 is a Lithium-Thionyl Chloride battery that provides a 3.6 V output. Preferably, battery 37 has a high energy density and is printed circuit board (PCB) compatible. One suitable example is a battery having part number LTC-7PN-S5, manufactured by Eagle-Picher Technologies, LLC of Joplin, Mo. At certain temperatures (e.g., temperatures below −50° C.), battery 37 may not be able to reliably supply its specified output (e.g., 3.6 V). Accordingly, the output of battery 37 is input to voltage regulator 39, which will provide a substantially constant voltage output.

According to one exemplary implementation, voltage regulator 39 will supply a substantially constant voltage that is lower than the voltage of battery 37. Thus, the voltage at voltage output 47 will be substantially constant, even as the voltage supplied by battery 37 fluctuates. According to one exemplary implementation of voltage regulator 39, the voltage at voltage output 47 is approximately 2.8 V. However, it should be appreciated that the invention is not limited in this respect and that other voltages may be used. For example, the voltage at voltage output 47 may be approximately 2.5 V according to another implementation. One suitable example voltage regulator has part number ZXCL280H5, and is manufactured by Zetex, Inc. of Hauppauge, N.Y.

Capacitor 41 is connected between voltage output 47 and ground output 49 of voltage regulator 39. At low temperatures, battery 37 may be slow in responding to a current draw, such as the current drawn when optical communications circuitry 29 is activated. Accordingly, capacitor 41 is provided to act as a buffer for current drawn on battery 37. Capacitor 41 will store a charge, and therefore will function as a small battery that can provide current. According to one exemplary implementation, capacitor 41 has a capacitance of 0.1 uF. Capacitor 41 may also function to reduce noise of the signal at voltage output 47, which may be generated by voltage regulator 39.

FIG. 4 illustrates an exemplary implementation of microcontroller 23 and LCD display 27, shown in FIG. 2. Microcontroller 23 may be any suitable microcontroller that is enabled to operate at very low temperatures. One suitable example is a microcontroller having part number ML63611A, manufactured by Oki Semiconductor of Sunnyvale, Calif. Circuitry is shown coupled to microcontroller 23, and may support the functions of microcontroller. For example, crystal 56 may be used to supply a clock LCD display 27 is coupled to microcontroller via a plurality of electrical connections 57 that are used to activate respective portions of the display. LCD display 27 may incorporate any combination of the features described in connection with LCD display 5 of FIG. 1. According to one exemplary implementation, LCD display 27 uses a low temperature fluid. As shown in FIG. 4, microcontroller 23 is coupled to circuitry 55. The details of circuitry 55 are illustrated in FIG. 5, described below.

FIG. 5 illustrates an exemplary implementation of temperature sensing circuitry 35, optical communications circuitry 29, user interface 33, and data memory 31, shown in FIG. 2. Each of temperature sensing circuitry 35, optical communications circuitry 29, user interface 33, and data memory 31 are coupled to microcontroller 23 of circuitry 53 (FIG. 4). Temperature sensing circuitry 31 includes a thermistor 59, which has a resistance that changes in response to temperature. A capacitor 61 is included in temperature sensing circuitry 31, which is charged through thermistor 59. The number of times capacitor 61 may be charged over a time period through thermistor 59 is determined and stored. This number is then compared to the number of times capacitor 61 may be charged over the same time period through a reference resistor. The ratio of the two numbers is compared with a lookup table to determine the temperature sensed by thermistor 59.

User interface 33 includes switches 63 and 65, which may correspond with control buttons 9a, 9b in FIG. 1A. Thus, switches 63 and 65 may be used to provide control signals to microcontroller 23 in any of the manners for providing signals discussed in connection with FIG. 1A. Switches 63 and 65 may control the state of the monitor (e.g., on or off), the information that is displayed on LCD display 27, and/or another aspect of monitor 22. It should be appreciated that switches 63 and 65 are not limited to the configuration shown and described in FIG. 1A and may assume any of the configurations described herein for accepting user input or another suitable configuration.

Optical communications circuitry 29 comprises a phototransistor 67 and an infrared LED 69. Signal 52 provides power to optical communications circuitry 29. Phototransistor 67 receives optical signals, while infrared LED 69 transmits optical signals. Phototransistor 67 and infrared LED 69 may respectively receive or transmit signals in any of the manners discussed in connection with the optical ports 7a, 7b of with FIG. 1. For example, phototransistor 67 may receive configuration data and/or commands transmitted from an optical port coupled to a personal computer, PDA, or other remote device. Infrared LED 69 may transmit measured or processed temperature data to an optical port of a personal computer, PDA, or other remote device. It should be appreciated that the configuration of optical communications circuitry 29 is merely exemplary and that other configurations are possible. For example, the communications circuitry may be unidirectional rather than bidirectional, or may use transmission mediums other than or in addition to those described. Such transmission mediums may use wires or be wireless.

According to one exemplary implementation, data memory 31 comprises an electrically erasable programmable read only memory (EEPROM) that requires a supply voltage equal to or less than that generated by power supply 25 (FIG. 3). One suitable example is an EEPROM having part number 24LC32A, manufactured by Microchip Technology Inc. of Chandler, Ariz. Memory 31 may store the measured and/or processed temperature data, for example. Signal 52 provides power to data memory 31.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A temperature monitor, comprising:
a housing;
a temperature sensor to provide temperature indications, wherein the temperature sensor is disposed inside the housing and exposed to an ambient temperature;
circuitry within the housing for processing and storing the temperature indications;
a power supply within the housing and coupled to the circuitry, wherein the power supply is adapted to provide a level of power to the circuitry sufficient for the operability of the circuitry at least at any ambient temperature between −40° C. and −80° C.

2. The temperature monitor of claim 1, wherein the temperature monitor further comprises a display coupled to the housing.

3. The temperature monitor of claim 2, wherein the display is a liquid crystal display.

4. The temperature monitor of claim 2, further comprising:
a user interface, wherein information displayed on the display may be controlled via the user interface.

5. The temperature monitor of claim 1, wherein the power supply comprises:
a battery that generates a battery output; and
a voltage regulator that receives the battery output and outputs a regulated output.

6. The temperature monitor of claim 5, wherein the battery output has a higher voltage than the regulated output.

7. The temperature monitor of claim 6, wherein the battery output has a voltage of approximately 3.6 V at room temperature.

8. The temperature monitor of claim 6, wherein the regulated output has a voltage of approximately 2.8 V.

9. The temperature monitor of claim 5, wherein the regulated output has a substantially constant voltage.

10. The temperature monitor of claim 5, wherein the power supply further comprises a capacitor coupled between the regulated output and ground.

11. The temperature monitor of claim 1, wherein the power supply comprises:
a battery that generates a battery output; and
a voltage regulator that receives the battery output and outputs a regulated output.

12. The temperature monitor of claim 1, wherein the temperature monitor further comprises an adhesive coupled to an exterior of the housing.

13. The temperature monitor of claim 1, wherein the temperature monitor further comprises optical communications circuitry for transmitting information from the housing.

14. The temperature monitor of claim 13, wherein the temperature monitor further comprises optical communications circuitry for receiving information at the housing.

15. The temperature monitor of claim 1, wherein the temperature monitor is probeless.

16. The temperature monitor of claim 1, wherein the ambient temperature equilibrates to a temperature external to the housing.

17. A method, comprising acts of:
exposing the interior of a housing to a temperature below −40° C.;
measuring the temperature in the interior of the housing;
storing an indication of the temperature within the housing; and
processing the indication of the temperature within the housing.

18. The method of claim 17, wherein the act of exposing comprises exposing the interior of a housing to a temperature below −60° C.

19. The method of claim 17, wherein the act of exposing comprises exposing the interior of a housing to a temperature below −80° C.

20. The method of claim 17, further comprising an act of placing the housing in container with dry ice.

21. The method of claim 17, wherein the act of processing comprises processing at least the indication of the temperature within the housing to generate temperature information, wherein the method further comprises an act of:
displaying the temperature information on a display coupled to the housing.

22. The method of claim 17, wherein the indication of temperature is stored within a memory and processed by a microcontroller, and wherein the method further comprises an act of:
providing substantially constant power to the memory and the microcontroller.

23. The method of claim 22, further comprising an act of:
regulating an output of a battery to generate a regulated supply voltage;
wherein the act of providing substantially constant power to the memory and the microcontroller comprises providing the regulated supply voltage to the memory and the microcontroller.

24. A temperature monitor, comprising:
a housing;
a temperature sensor to provide temperature indications; and
means, within the housing, for processing and storing the temperature indications, wherein said means is operable when exposed to a temperature of approximately −80° C.

25. The temperature monitor of claim 24, wherein the temperature sensor is within the housing.

26. The temperature monitor of claim 24, wherein means further comprises a display mechanically coupled to the housing and electrically coupled to the means for processing and storing.

27. The temperature monitor of claim 24, wherein the temperature monitor is probeless.

28. A device, comprising:
a probeless temperature monitor, wherein the monitor is operable down to at least −80° C.
